(19) United States
(12) Patent Application Publication
(10) Pub. No.: US 2024/0209884 A1
(43) Pub. Date: Jun. 27, 2024

(54) FASTENING DEVICE

(71) Applicant: ILLINOIS TOOL WORKS INC., Glenview, IL (US)

(72) Inventor: Laurent HUET, Meru (FR)

(21) Appl. No.: 18/568,679

(22) PCT Filed: Jun. 14, 2022
(86) PCT No.: PCT/US2022/033326

§ 371 Date: Dec. 8, 2023

(30) Foreign Application Priority Data
Jun. 16, 2021 (EP) 21179706.3
Sep. 9, 2021 (EP) 21195694.1

(51) Int. Cl. F16B 5/06

(52) U.S. Cl. CPC F16B 5/0642

(57) ABSTRACT

A fastening device adapted to fasten a first part and a second part includes a main body; a first locking device for cooperating with a first fastening part of the main body and adapted to come into abutment against the first part; a second locking device for cooperating with and tightening a second fastening part of the body and adapted to come into abutment against the second part; a part for rotating the body along a longitudinal axis substantially perpendicular to the two parts; the second locking device including at least one part adapted to increase the clamping force of the second fastening part when the body is rotated between a first position, the open position, and a second position, the closed position, the second locking device being removable from the second part.

### TECHNICAL FIELD

This invention relates to fastening device for the automotive industry, but not exclusively. More precisely, the invention concerns a fastening device for fixing a bus bar connector on a battery.

### BACKGROUND

A bus bar connector is a metal strip or bar that conducts electricity and is used for electrical power distribution. Battery modules (each module being made of cells) can be connected together with such bus bar to make battery packs. FIGS. 1 and 2 show bus bar connectors 31′, 32′ connected to respective battery terminals “+” 12′ and “−” 11′ as shown particularly for the battery illustrated in FIG. 2. Each bus bar 31′, 32′ is typically fixed onto the corresponding battery terminal via threaded studs 2′ and corresponding nuts (not shown). This assembly provides for a removable connection that guarantees sufficient surface contact between the bus bars 31′, 32′ and the metallic contact (“+” or “−”) of the battery terminals.

However, using a stud and nut coupling requires the use of particular tools, such as, for example, a screwdriver or power tool screwdriver etc. Thus, assembling the busbars with the battery can be a slow process, and a connection by stud 2′ and nut can become unsafe if, for example, the nut is not correctly placed onto the thread of the stud 2′ during assembly. In addition, such a screw-type connection is generally very bulky.

Consequently, the present invention seeks to alleviate at least some of these issues and propose a safer and quicker solution to secure a bus bar to a battery (or more generally, a module), as well as, provide a more compact coupling with between the battery and the busbar 31′, 32′.

### BRIEF SUMMARY OF THE DISCLOSURE

Viewed from a first aspect, the present invention provides a fastening device adapted to fasten a first and a second part, said fastening device comprising:
a main body adapted to be inserted in a hole provided in each part to be joined together;
a first locking means removable and intended to cooperate with first fixing means (located at a first end of the main body, said first locking means being adapted to come into abutment against the first part to be assembled once the body has been inserted into the orifices of the two parts to be assembled;
a second locking means designed to cooperate with and tighten second fastening means located at a second end of the main body, said second locking means being adapted to come into abutment against the second part to be assembled once the body has been inserted into the orifices of the two parts to be assembled;
means or rotating the body along a longitudinal axis substantially perpendicular to the two parts to be assembled;
said second locking means comprising at least one part adapted to increase the clamping force of the second fastening means when the body is rotated by said rotating means between a first position, called the open position, and a second position, called the closed position

According to a characteristic of the invention, said portion adapted to increase the clamping force of the second fastening means is ramp-like

According to a characteristic of the invention, said part adapted to increase the clamping force of the second fastening means comprises two ramps

Remarkably well, the first clamping means is made of a flexible material

According to a characteristic of the invention, the first fastening means are adapted to conform with third fastening means of the first locking means

According to an another characteristic of the invention, the first clamping means comprises tolerance compensation means when tightening the second clamping means

Also, the second locking means and the second fastening means respectively comprise first and second pre-assembly means so as to keep the fastening device in the first so-called open position

Also, the second locking means comprises first means for locking the second fastening means against rotation

According to a characteristic of the invention, the second blocking means comprises second means for blocking the rotation of the second fastening means in the second so-called closed position

According to an another characteristic of the invention, the second rotation locking means are integral parts of the first pre-assembly means

In different embodiments, rotation means of the body are attached to or integral with said fastening device

Also, the second locking means is an integral part of a device supporting the second part, the integral part being a battery cell part, the second part being a metal part and the first part being a battery connection bus bar.

### BRIEF DESCRIPTION OF THE DRAWINGS

Embodiments of the invention are further described hereinafter with reference to the accompanying drawings, in which:

FIG. 1 is a partial top-view of a bus bar configuration according to a solution known in the art, using a threaded stud and nut to secure a bus bar to a metallic contact of a battery;

FIG. 2 is a partial perspective view of the battery shown in FIG. 1, but without the connected bus bars;

FIGS. 3A-3E show a step-by-step process of connecting a bus bar to a battery contact using an embodiment of the fastening device of the present invention;

FIG. 4 shows a perspective bottom view of the fastening device of FIGS. 3A-3E, in use, and before the bus bar is lockingly secured;

FIGS. 5A-5F show another embodiment of the fastening device of the invention, comprising (a) an insert stud member, (b) a locking bracket, (c) a base module, (d) a contact cover, (e) a perspective view of the assembled fastening device, and (f) a cross-sectional perspective view of the assembles fastening device;

FIGS. 6A-6D show a step-by-step process of connecting a bus bar to a battery contact using the fastening device of FIGS. 5A-5F;

FIGS. 7A-7B show the fastening device of FIGS. 5A-5F in (a) an open configuration and (b) a closed configuration;

FIG. 8 shows a partial cross-sectional view of the assembled fastening device of FIGS. 5A-5F;

FIGS. 9A-9B show a close-up perspective view of the flexible skirt element of the assembled fastening device of FIGS. 5A-5F (a) from the top and (b) from the bottom;

FIGS. 10A-10E show various perspective views of the base module coupled with the stud member of the fastening device of FIGS. 5A-5F when in the preassembled arrangement;

FIGS. 11A-11B show (a) a partial cross-sectional perspective view and (b) a partial perspective view of the base module, including the cam feature (ramp) and hook members, and

FIGS. 12A-12B show (a) a close-up view of the base module coupled to the stud member when in the locked position, and (b) a perspective top view of the stud member including a tool insert having a Torx footprint.

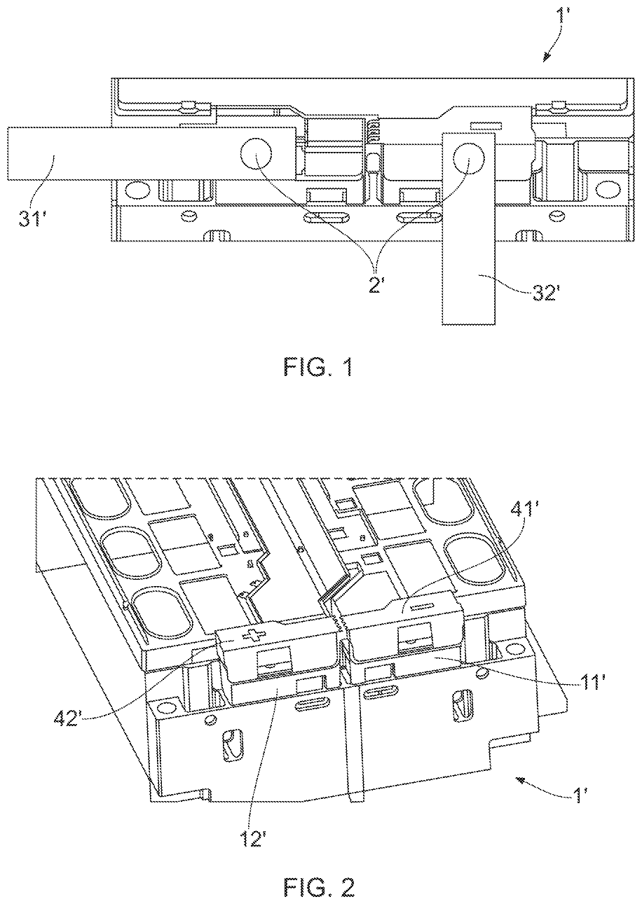

### DETAILED DESCRIPTION

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’ and ‘outer’, ‘outwardly’ refer to directions toward and away from, respectively, a designated centreline or a geometric centre of an element being described (e.g. central axis), the particular meaning being readily apparent from the context of the description.

Further, as used herein, the terms ‘connected’, ‘attached’, ‘coupled’, ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, “first”, “second”, “third” etc. merely indicate that different instances of like objects are being referred to and are not intended to imply that the objects so described must be in a given sequence, either temporally, spatially, in ranking or in any other manner.

Like reference numerals are used to depict like features throughout.

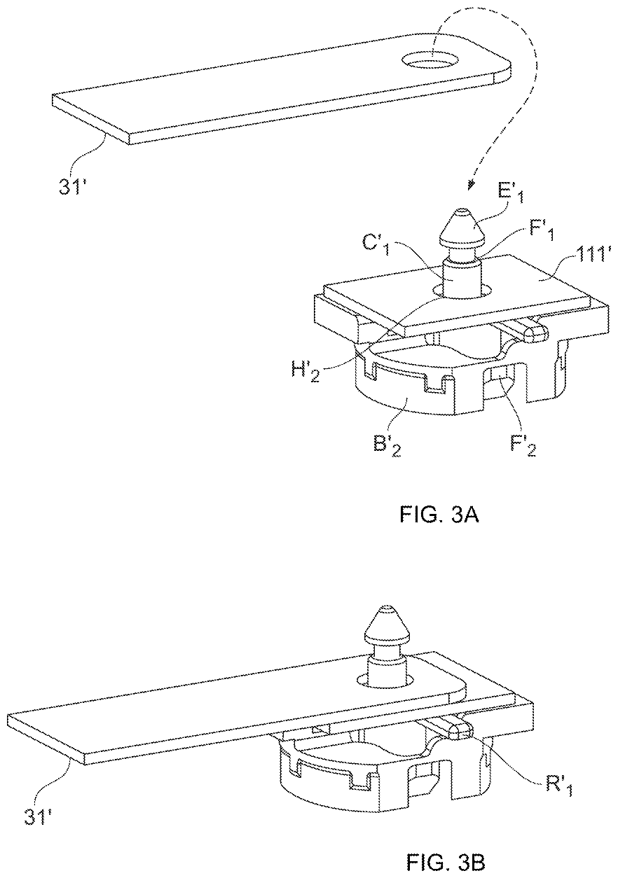

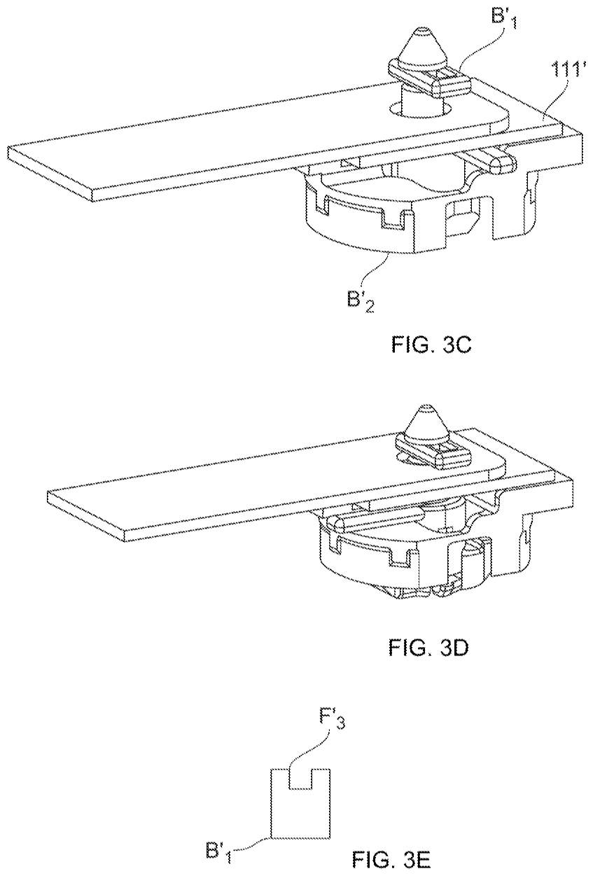

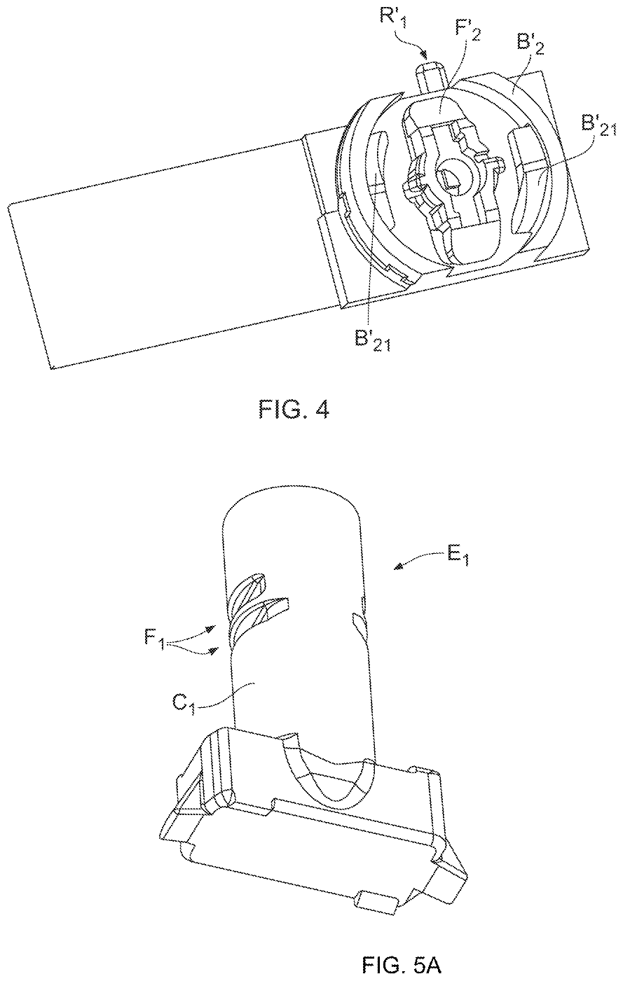

Referring now to FIGS. 3A-3E and FIG. 4, a first embodiment of the fastening device A′1 of the present invention is shown in situ.

As illustrated in the step-by-step series of process steps, FIG. 3A shows the bus bar 31′ before it is contactingly engaged with the battery's metallic (electrical) terminal 111′. Both, the bus bar 31′ (first member) and the metallic terminal 111′ (second part) are operably coupled utilising the fastening device A′1 of the present invention. Of course, it is understood by the person skilled in the art that the present invention can be used to operably couple and secure more than two members (for example additional bus bars or conductors).

The fastening device A′1 comprises a substantially cylindrical main body C′1 adapted to be inserted through apertures H′1, H′2 provided in each one of the members that are joined together. In this particular example, the bus bar 31′ has aperture H′1 and the metallic terminal 111′ of the battery has an aperture H′2.

The fastening device A′1 also comprises a removable first locking member B′1 (e.g. a clamp) configured to cooperate with a first fixing means F′1 located at a first end E′1 of the main body C′1 so as to prevent the main body C′1 from moving out of respective apertures H′1, H′2. In this particular example embodiment, the first fixing means F′1 is a circumferential groove provided at the first end portion E′1 (i.e. the distal end portion of the main body C′1) and the first locking member B′1 is adapted to retainingly slide into engagement with the circumferential groove of the first fixing means F′1 to then provide a stop for the first part (i.e. the bus bar 31′) once the main body C′1 has been pushed through the apertures H′1 and H′2 of the bus bar 31′ and battery terminal 111′.

The fastening device A′1 further comprises a second locking member B′2 configured to cooperatingly engage with a second fastening means F′2 of the fastening device A′1, as shown in particular in FIG. 4. The second fastening means F′2 is a retainer portion (i.e. having two axially opposing fingers extending radially outward from the main body C′1) that is located at a second end E′2 (i.e. a proximal end portion) of the main body C′1. The second locking member B′2 is configured to abut against a bottom surface of the second part (i.e. the substantially planar battery terminal) 111′ during assembly and retainingly and lockingly tighteningly engage with the second fastening means F′2 of the main body C′1.

Furthermore, the fastening device A′1 comprises suitable means for rotating R′1 the main body C′1 about its longitudinal axis. The means for rotating is a lever R′1 extending away from an outer surface of the main body C′1 in a direction perpendicular to the longitudinal axis of the main body C′1. Thus, the lever R′1 is also arranged substantially perpendicular to the two parts (i.e. bus bar 31′ and terminal 111′) to be assembled.

The second locking means B′2 comprises at least two axially opposing ramp members B′21 adapted to increase the clamping force between the second fastening means F′2 (i.e. extending fingers) and the first locking member B′1 when the main body C′1 is rotated about its longitudinal axis from a first position (see FIG. 3C), i.e. an open position, to a second position (see FIG. 3D), i.e. a closed or locked position. In particular, the lever R′1 is rotated 90 degrees about the longitudinal axis of the main body C′1, thus, rotating the retainer portion (i.e. fingers) into engagement with a cam surface of the ramp members B′21 and translating into a longitudinal movement of the second locking means B′2 relative to the main body C′1 of the fastening device A′1, i.e. the second locking means is pressed against the bottom surface of the battery terminal 111′, squeezing the busbar 31′ and terminal 111′ into a tight contact engagement.

Therefore, this so called ramp clamping mechanism of the present solution makes it possible to replace the cumbersome and time consuming screw and nut fastener and provide for a faster assembly and improved ease of use, while also being a more reliable fixing of the bus bar.

During use/assembly, the aperture of the second locking member B′1 is coaxially aligned with the apertures H′2 and H′1 of the overlayed terminal 111′ and busbar 31′ and the cylindrical main body C′1 is simply pushed through the coaxial apertures and secured by the first locking member B′1 (i.e. a clip engaging the groove on the main body C′1). The lever of the means of rotation R′1 is then moved by a quarter turn moving the fingers of the retainer portion F′2 over the ramp members B′21 and pushing the second locking member B′2 towards the bottom surface of the terminal 111′ thus compressing the contactingly engaged busbar 31′ and battery terminal 111′ together, i.e. the rotational movement of the main body C′1 is translated into an axial movement of the second locking member B′2 relative to the main body C′1. In order to release the compression force and unlock the busbar 31′ from the terminal 111′, the lever R′1 is simple turned back by a quarter turn (e.g. counter-clockwise), moving the fingers of the retainer portion F′2 down the ramp and releasing the pressure between the second locking member B′2 and the bottom surface of the terminal 111′. The first locking member B′1 (clip) can now be removed and the main body C′1 can be moved out of the coaxially aligned apertures H′1, H′2 of the bus bar 31′ and terminal 111′ and the second locking member.

The first locking member B′1 may be made from a resilient and flexible material that allows dimensional tolerances, as well as, ensures a strong connection, but may also prevents or at least minimises transmission of any vibrations, i.e. the material is adapted to absorb or mitigate potentially harmful vibrations.

It is understood by the person skilled in the art that any suitable means for rotation R′1 can be used to rotate the main body C′1, such as, for example, the lever attached to or integral with the main body C′1 of the fastening device. Other means may include a tool insert at the distal end portion of the main body C′1. Further, it is understood by the person skilled in the art that the clip space F′3 of the first locking means B′1 is configured to operably engage with the first fixing means F′1 (i.e. groove).

Also, the second locking means B′2 may be an integral part of a device supporting the second part, the integral part being a portion of the battery module, the second part being a metal terminal of the battery and the first part being a bus bar.

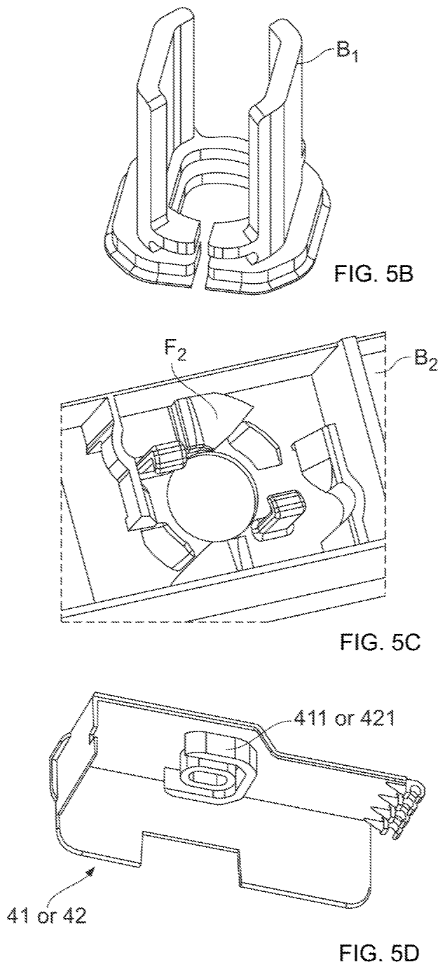

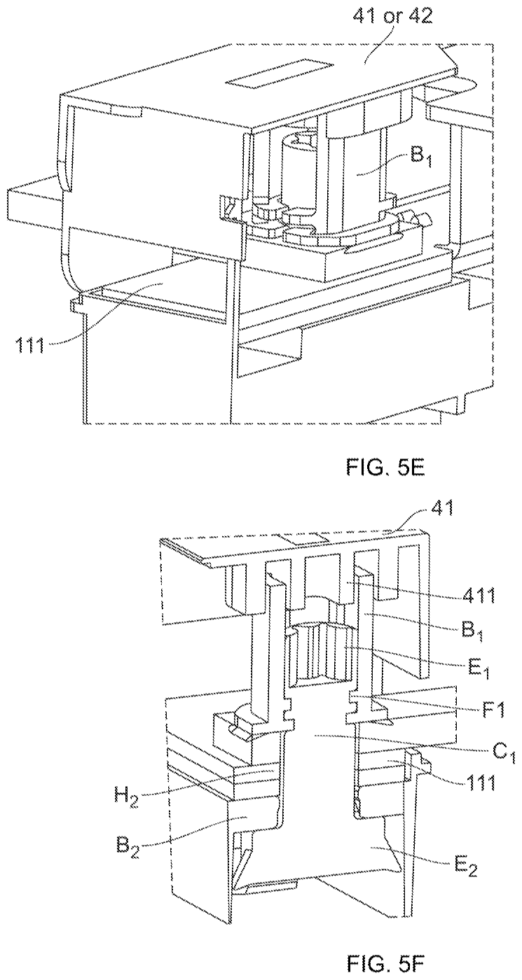

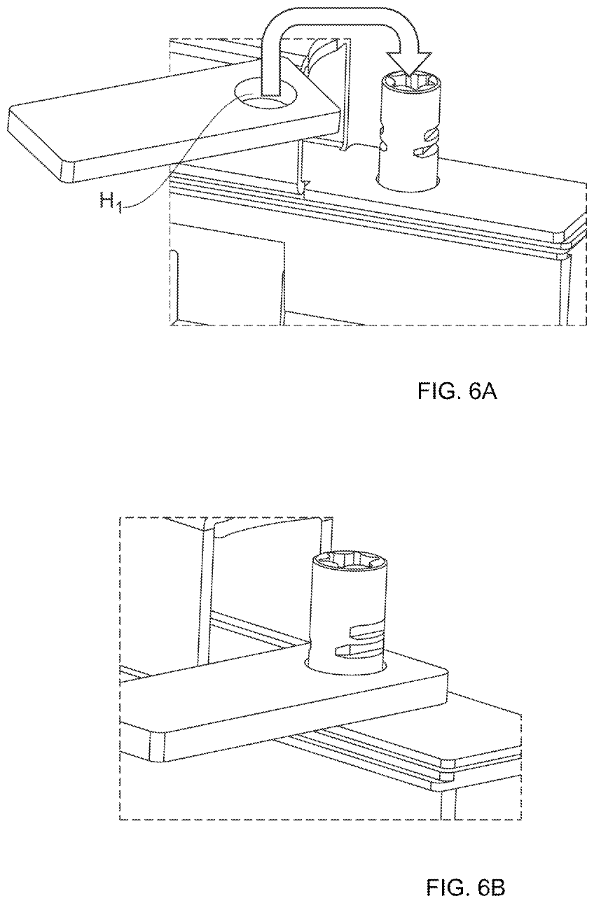

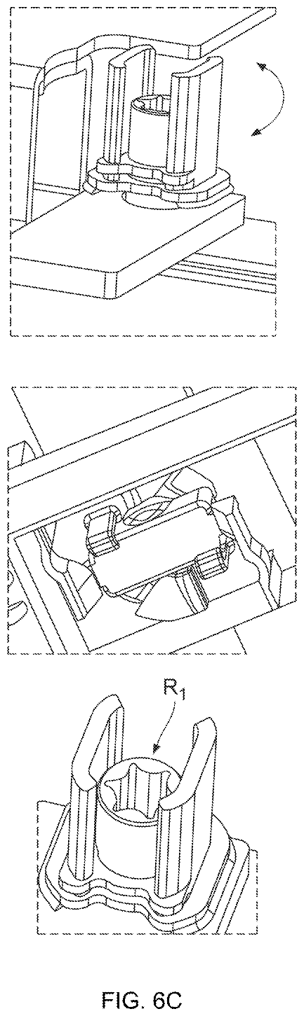

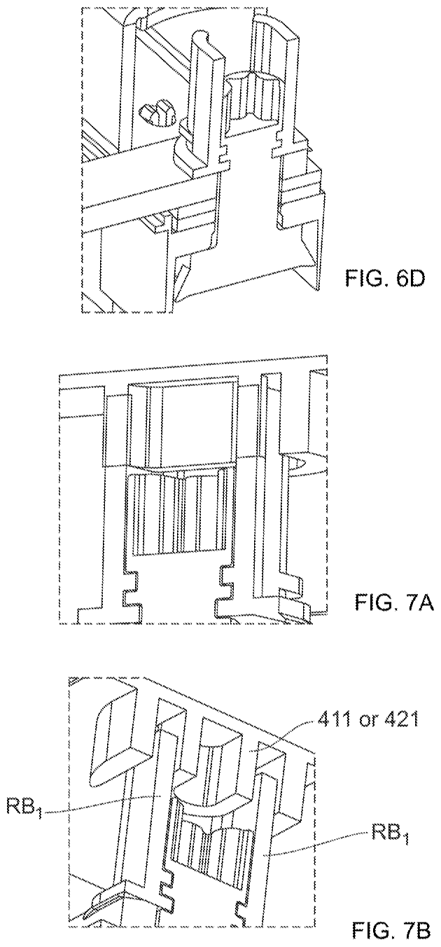

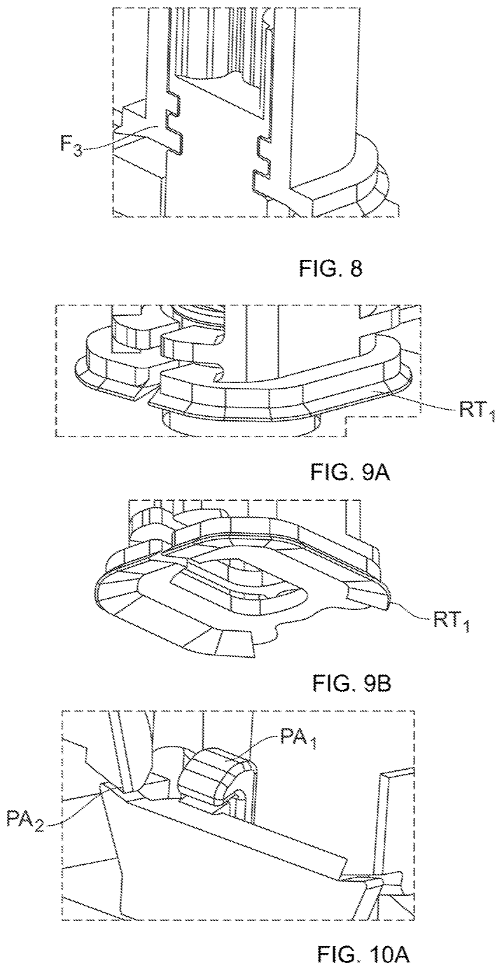

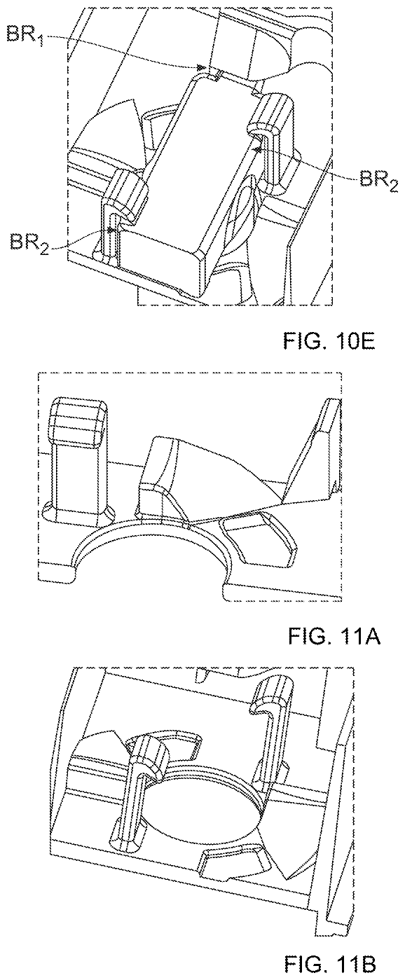

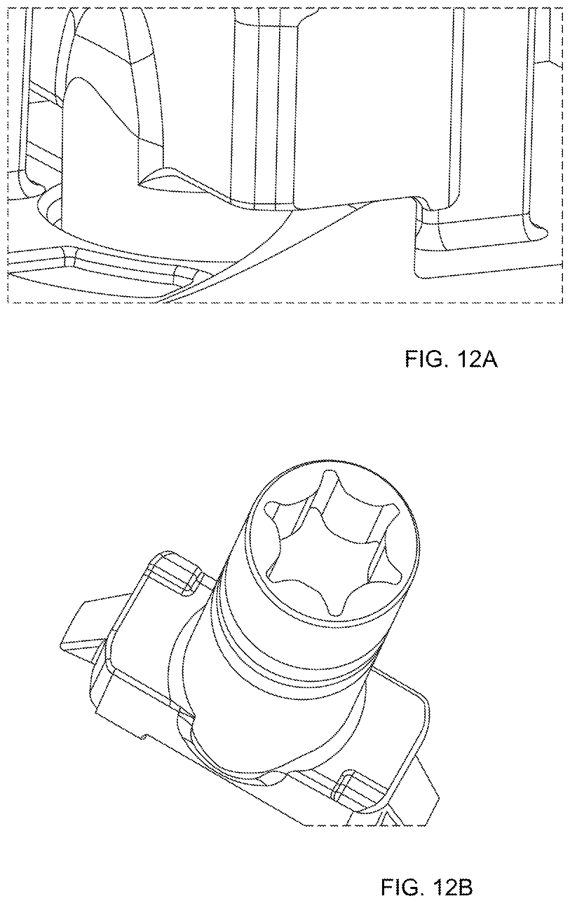

Referring now to FIGS. 5A-5F, 6A-6D, 7A-7B, 8, 9A-9B, 10A-10E, 11A-11B and 12A-12B, an alternative embodiment A′2 of the present invention is shown.

This alternative example embodiment comprises a fastening device adapted to fasten a first part (i.e. bus bar) with a second part (battery terminal). The basic mechanism of the fastening device A2 of the alternative embodiment of the present invention is substantially the same as the first example embodiment A′1 and like parts are provided with like reference numerals (but without the apostrophe). The fastening device A2 comprises a main body C1 configured to pass through respective apertures H1, H2 of the bus bar 31, the battery terminal 111 as well as the second locking member B2 when joined together; a first removable locking member B1 configured to cooperate with first fastening means F1 (grooves) located at a first (distal) end E1 of the main body C1. The first locking member B1 (clip or cap) is adapted to abuttingly engage with the busbar 31 when assembled and once the main body C1 has been inserted through respective apertures H1, H2. The fastening device A2 further comprises a second locking member B2 configured to cooperate with a second fastening means F2 (retainer portion) located at a second (proximal) end portion E2 of the main body C1 The second locking member B2 is adapted to abuttingly engage with a bottom surface of the batter terminal (i.e. a substantially planar metal part) once the main body C1 has been inserted through respective apertures of the assembly A2. Further, the first end portion (distal) E1 of the main body C1 is provided with means R1 for rotating the main body C1 about its longitudinal axis. When assembled, the longitudinal axis of the main body C1 is substantially perpendicular (i.e. normal) to the two parts 31, 111 that are to be assembled. Also, the second locking member B2 comprises at least one ramp member B21 (preferably more than on) that is adapted to cooperate with the fingers of the second fastening means F2 so as to increase the clamping force between the second fastening means F2 and the first locking member B1 when the main body C1 and respective fingers of the second fastening means F2 are rotated from a first position, i.e. an open position, to a second position, i.e. a closed position. The second locking member B2 may be removably engaged with the terminal 111.

The first locking member B1 may be made from a resilient or flexible material so as to allow for dimensional tolerances, as well as, ensure a strong connection, but also prevent or at least minimise the transmission of any vibrations.

As illustrated particularly in FIGS. 7A and 7B, the first locking member B1 comprises ribs RB1 forming a footprint matching a footprint of corresponding ribs 411, 421 of a battery terminal cover 41, 42. The footprint of each of the ribs RB1 and 411, 421 is such that the cover 41, 42 will only fit into connection with the first locking member B1 at a predetermined angular orientation between the first locking member B1 and the cover 41, 42. I.e. the first locking member B1 is lockingly engaged with the main body C1 by rotating the first locking member B1 with respect to the main body C1 (so as to engage the first fastening means F1) to then allow the ribs 411, 421 of the cover 41, 42 to fit onto the ribs RB1. In case the first locking member B1 is not properly fitted onto the main body C1 (i.e. not rotated into lock position), the cover 41, 42 will not fit onto the ribs RB1. In this example embodiment, the corresponding cover 41, 42 is made of a plastic material and used to indicate the battery terminal polarity “+” or “−”. The footprint of corresponding ribs RB1 and 411, 421 provide for a “poka-yoke” configuration, adapted to prevent mistakes when connecting to the terminals. If the fastener is not well assembled, the ribs are in interference and the user is alerted that there may have been a problem during assembly.

The first fastening means F1 (grooves) are adapted to conform with third fastening means F3 (respective rib members) of the first locking member B1. Further, the first locking member B1 comprises tolerance compensation means RT1 (i.e. flexible skirt member) when assembled. I.e. when the fastening device A2 assembled to the busbar 31 and terminal 111 and tightened, the skirt member provides for a snug contact between the first locking member B1 and the busbar 31. The flexible skirt member RT1 is adapted to absorb vibrations and ensure a strong connection.

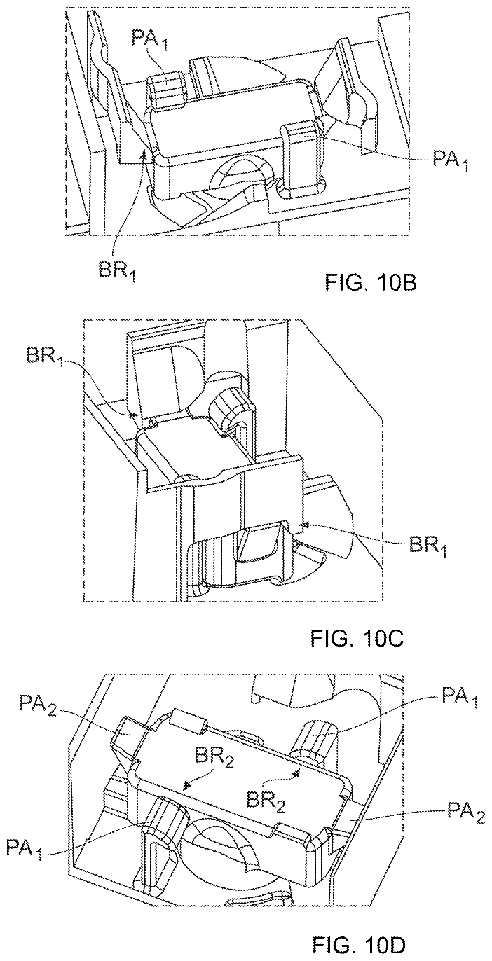

In this alternative example embodiment A2, and as shown in FIGS. 10A-10E, the second locking member B2, as well as, the second fastening means F2 (fingers of retainer portion) further comprise respective first and second pre-assembly means PA1 and PA2 (i.e. respective hook and teeth elements). The pre-assembly means PA1, PA2 are configured to retain the fastening device A2 when in its open position (e.g. during transport). The pre-assembly means PA1, PA2 may be provided in the form of hook and teeth members, wherein the teeth members PA2 on the fingers of the retainer portion F2 are adapted to retainingly engage with first catch means BR1 (e.g. ribs) the second locking member B2 so as to prevent the main body C1 from sliding out of the apertures H1, H2 when in the open position, and wherein the hook members PA1 of the second locking member B2 are adapted to retainingly engage with respective teeth PA2 provided on the fingers of the retainer portion F2 (second fastening means) so as to prevent rotation of the main body C1 when in the open position.

The hook members of the first pre-assembly means PA1 are positioned such as to also prevent further clockwise rotation of the main body C1 when in the pre-assembled, i.e. the open position (see FIG. 10(c)), and to prevent further counter-clockwise rotation of the main body C1 when in the assembled, i.e. closed position (see FIG. 10(d)).

The first pre-assembly means PA1 may be an integral part of a device supporting the second part. In this example, the integral part is a portion of a battery module , the second part a metal terminal 111 of the battery and the first part a connection bus bar 31.

In use, the main body C1 of the fastening device A2 is pushed through the aperture of the second locking means B2 and clipped into its pre-assembled position by engaging the first and second pre-assembly means PA1 and PA2 with respective second catch means BR2 (i.e. teeth on fingers) and first catch means BR1 (i.e. ribs on second locking member B2) (see FIG. 10(a) and (b)). In this pre-assembled arrangement, the pre-assembled fastening device A2 can be transported safely. When at the assembly point/station, the main body C1 of the pre-assembled fastening device A2 is pushed through respective coaxially aligned apertures H1, H2 of the busbar 31 and the metal terminal 111 and the first locking member B1 is clipped onto the first end portion E1 of the main body C1 and rotated into locking engagement, i.e. third fastening means F3 (first locking member B1 interior ribs) are engaged with first fastening means F1 (grooves on main body C1). At this point, a tool (e.g. a Torx screw driver) is used to rotate the main body C1 and respective retainer portion F2 from the open position (pre-assembled) into the closed position sliding the finger members of the retainer portion F2 over the two ramp members B21 and translating the rotation into an axial movement of the second locking member B2 towards the terminal 111, thus increasing the clamping force between the first locking member B1 and the second locking member B2. When locked a terminal cover member 41, 42 is connected to the first locking member B1 by sliding ribs 411, 421 forming a predetermined footprint on the terminal cover 41, 42 onto a suitably matching footprint formed by the ribs RB1 on the first locking member B1. The foot prints formed by the respective ribs 411, 421 and RB1 are such that the terminal cover 41, 42 will only fit into its dedicated slot (on the battery terminal) when the fastening device A2 is correctly assembled and in its closed position. During disassembly, the terminal cover 41, 42 is simple unplugged from the first locking member B1 and the main body and respective retainer portion F2 is rotated back from the closed position into its open position using a suitable screwdriver tool (e.g. Torx) on the means for rotating R1 (e.g. Torx footprint). When in the open position, the main body C1 and second locking member B2 can be moved out of engagement with the clamped busbar 31 and terminal contact 111. In this particular example embodiment, the fastening device A′1, A2 is moved between the open and closed position by a quarter turn of the main body C1. However, it is understood by the person skilled in the art that a different arrangement may be used to require either less than a quarter turn or more than a quarter turn to move the fastening device A′1, A2 between its open and closed position.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

Reference numbers:

| | | | |
|---|---|---|---|
| 1′ | Battery | A2 | Fastening device (alternative |
| 2′ | Threaded studs | | embodiment) |
| 11′ | Battery terminal ‘-’ | B1 | First locking member (clip, cap) |
| 12′ | Battery terminal ‘+’ | B2 | Second locking member (base |
| 31′ | Bus bar | | bracket) |
| 32′ | Bus bar | B21 | Ramp members |
| 111′ | battery terminal | C1 | Main body |
| A′1 | Fastening device (first | E1 | First end portion (distal) |
| | embodiment) | E2 | Second end portion (proximal) |
| B′1 | First locking member | F1 | First fastening means (clip/cap) |
| B′2 | Second locking member | | |
| B′21 | Ramp members | F2 | Second fastening means (retainer |
| C′1 | Main body | | portion with fingers) |
| E′1 | First end portion (distal) | F3 | Third fastening means (internal ribs |
| E′2 | Second end portion (proximal) | | of first locking member) |
| F′1 | First fixing means (groove) | H1 | Aperture (busbar) |
| F′2 | Second fastening means (retainer | H2 | Aperture (battery terminal) |
| | portion with fingers) | R1 | Means for rotation (e.g. Torx head) |
| F′3 | Clip space (of first locking | PA1 | First pre-assembly means (hook |
| | member) | | members) |
| H′1 | Aperture (bus bar) | PA2 | Second pre-assembly means (teeth) |
| H′2 | Aperture (battery terminal) | RB1 | Ribs with predetermined footprint |
| R′1 | Means for rotation (lever) | | (first locking member) |
| 31 | Busbar | BR1 | First catch means (ribs on second |
| 111 | Battery terminal | | locking member) |
| 41, | Battery terminal cover | BR2 | Second catch means (teeth on |
| 42 | | | fingers) |
| 411, | Cover ribs | RT1 | Tolerance compensation means |
| 421 | | | (flexible skirt) |

1. A fastening device adapted to fasten a first and a second part, wherein said fastening device comprises:
a main body adapted to be inserted in a hole provided in each part to be joined together:
a first locking means removable and intended to cooperate with first fastening means located at a first end of the main body, said first locking means being adapted to come into abutment against the first part to be assembled once the body has been inserted into the orifices of the two parts to be assembled;
a second locking means designed to cooperate with and tighten second fastening means located at a second end of the body, said second locking means being adapted to come into abutment against the second part to be assembled once the body has been inserted into the orifices of the two parts to be assembled:
means for rotating the body along a longitudinal axis substantially perpendicular to the two parts to be assembled;
said second locking means comprising at least one part adapted to increase the clamping force of the second fastening means when the body is rotated by said rotating means between a first position, called the open position, and a second position, called the closed position:
said second locking means being removable from the second part.

2. A fastening device according to claim 1, wherein said portion adapted to increase the clamping force of the second fastening means is ramp-like.

3. A fastening device according to claim 2, wherein said part adapted to increase the clamping force of the second fastening means comprises two ramps.

4. A fastening device according to claim 1, wherein said first locking means is made of a flexible material.

5. A fastening device according to claim 1, wherein the first fastening means are adapted to conform with a third fastening means of the first locking means.

6. A fastening device according to claim 1, wherein the first locking means (B1) comprises tolerance compensation means when tightening the second clamping means.

7. A fastening device according to claim 1, wherein the second locking means and the second fastening means (F2) respectively comprise first and second pre-assembly means so as to keep the fastening device in the first so-called open position.

8. A fastening device according to claim 1, wherein the second locking means comprises first means for locking the second fastening means against clockwise and counter-clockwise rotation.

9. A fastening device according to claim 1, wherein the second locking means comprises second means for blocking the rotation of the second fastening means in the second so-called closed position.

10. A fastening device according to claim 9, wherein the second rotation locking means are integral parts of the first pre-assembly means.

11. A fastening device according to claim 1, wherein the rotation means of the body are attached to or integral with said fastening device.

12. A fastening device according to claim 1 wherein the first blocking means comprises at least one ribs adapted to conform with corresponding ribs of a cover, said cover allowing to indicate the type of the battery pole.

13. A fastening device according to claim 1, wherein the second locking means is an integral part of a device supporting the second part.

14. A device according to claim 13, wherein the integral part is a portion of a battery module, the second part a metal part and the first part a battery connection bus bar.
